(19) United States
(12) Patent Application Publication
(10) Pub. No.: US 2005/0254769 A1
(43) Pub. Date: Nov. 17, 2005

(54) Optical connector and method of manufacturing the optical connector

(76) Inventors: Jiangron Qiu, Nara-Shi, Nara-Ken (JP); Kazuyuki Hirao, Kyoto-Shi, Kyoto-Fu (JP); Shuhei Yoshizawa, Takatsuki-Cho, Shiga-Ken (JP); Tamotsu Yajima, Takatsuki-Cho, Shiga-Ken (JP); Futoshi Ishii, Takatsuki-Cho, Shiga-Ken (JP)

Correspondence Address: THE WEBB LAW FIRM, P.C., 700 KOPPERS BUILDING, 436 SEVENTH AVENUE, PITTSBURGH, PA, 15219, US

(21) Appl. No.: 10/521,953

(22) PCT Filed: May 8, 2003
(86) PCT No.: PCT/JP03/05778

§ 371 Date: Jan. 21, 2005

(30) Foreign Application Priority Data
Jul. 23, 2002 (JP) 2002-214070

(51) Int. Cl. G02B 6/00

(52) U.S. Cl. 385/137

(57) ABSTRACT

An optical connector capable of providing a multicore ferrule for optical communication or a fiber array for optical communication having a high dimensional accuracy and easily manufactured at a low cost, comprising a plurality of insert holes for inserting optical fibers therein arranged at specified intervals, characterized in that the accuracy of the center-to-center distances between the adjacent insert holes is within ±0.5 μm and a parallelism between the adjacent insert holes in hole axial direction is within ±0.1°.

### TECHNICAL FIELD

The present invention relates to an optical connector for optical fiber connection, particularly a multi-core optical connector.

### BACKGROUND ART

Increased speed and increased capacity of information transmission in recent years have led to widespread use of information communication using optical fibers. The information communication using optical fibers requires connection between optical fibers themselves or between an optical fiber and optical information equipment. Optical connectors such as ferrules for optical communication and fiber arrays for optical communication have been used for such connection. Demands for size reduction and high-density integration have led to a tendency toward the use of multi-core optical connectors.

Due to the nature of the structure of the optical connector that optical fibers are fitted into and fixed to respective insertion holes formed in a substrate, in order to prevent connection loss of optical fibers, the dimensional accuracy of insertion holes should be regulated on a submicron order from the viewpoint of avoiding deviation of the optical axis of the optical fibers. The adoption of the multi-core or reduced-size optical connector has led to a demand for higher dimensional accuracy.

In the case of conventional fiber arrays or ferrules manufactured by conducting injection molding or extrusion and then subjecting the molding to steps of baking and working, achieving the dimensional accuracy of insertion holes, into which optical fibers are to be inserted, within 1 μm is difficult due to the nature of the process.

To overcome this difficulty, structures as described, for example, in Japanese Patent Laid-Open No. 174274/1999 have been used including a structure in which V-shaped grooves are formed in a substrate such as a silicon dioxide or silicon substrate and optical fibers are held and fixed by a press cover, and, in the case of a ferrule, a structure in which insertion holes are formed in zirconia ceramic or the like and optical fibers are fitted into and fixed to the holes. In this working method, unlike the above molding technique, V-shaped grooves or insertion holes are formed by cutting, and finish processing is performed with a grind stone. In this method, the V-shaped grooves or insertion holes can be formed with dimensional accuracy within 0.5 μm.

This method, however, is disadvantageous in that the shape of the grind stone should always be corrected in order to keep the dimensional accuracy of V-shaped grooves or insertion holes on a constant level, resulting in poor productivity. Further, ferrules using zirconia ceramic as the substrate suffer from a problem that working stress applied at the time of cutting causes transition of the crystal structure of the substrate and, consequently, the substrate is disadvantageously expanded, making it impossible to ensure the dimensional accuracy.

Accordingly, an object of the present invention is to provide a multi-cored ferrule or fiber array for optical communication which has high dimensional accuracy, can easily be prepared by machining, and is low in cost.

### DISCLOSURE OF THE INVENTION

The above object of the present invention can be attained by an optical connector comprising a plurality of insertion holes for inserting optical fibers therein, said insertion holes being provided at predetermined intervals, the accuracy of the center-to-center dimension between said insertion holes adjacent to each other being within ±0.5 μm, the degree of parallelization in the hole axis direction between said insertion holes adjacent to each other being within ±0.1 degree. The dimensional accuracy of the insertion holes can realize the provision of an optical connector with no significant coupling loss.

In a preferred embodiment of the present invention, the insertion holes are arranged in a two-dimensional honeycomb form. The provision of insertion holes in a two-dimensional honeycomb form can increase the number of optical fibers per unit sectional area and thus can realize high-density integration and, at the same time, can reduce the coupling loss.

In a more preferred embodiment of the present invention, in said insertion holes, the insertion hole end on the optical fiber insertion side has been tapered. The adoption of the taper shape on the optical fiber insertion side can reduce latent damage at the time of optical fiber insertion and damage to optical fibers during the use of the optical connector.

More preferably, the optical connector comprises a substrate formed of a material selected from the group consisting of glass composed mainly of silicon oxide, glass ceramic, quartz glass, translucent alumina, and zirconium oxide. The use of the transparent substrate can avoid heat damage to the substrate during laser beam machining.

The optical connector according to the present invention may be a ferrule for optical communication or a fiber array for optical communication. In the array for optical communication according to the present invention, as compared with the conventional array which requires the use of a substrate with V-shaped grooves and a press plate, the necessary number of components can be reduced and, in addition, the array can be produced in a simpler and lower-lost manner.

According to another aspect of the present invention, there is provided a method for manufacturing the optical connector, said method comprising the steps of: fixing a substrate for said optical connector; regulating the hole axis direction on an optical fiber insertion side in said fixed substrate; and forming insertion holes in the substrate with regulated hole axis direction by pulsed laser beam machining.

Preferably, the method comprises the step of continuously conducting the formation of said insertion holes and the formation of said taper part of a predetermined angle by pulsed laser beam machining. More preferably, the pulsed laser beam is a femtosecond laser beam. The formation of the taper part continuous from the formation of the insertion holes can enhance the productivity.

More preferably, the method comprises the step of, in forming the insertion holes by pulsed laser beam machining, shaping the end of said insertion holes into a taper of a predetermined angle, more preferably by etching treatment with at least one inorganic acid selected from the group consisting of hydrofluoric acid, hydrochloric acid, nitric acid, and sulfuric acid. The etching treatment can enhance the fabrication accuracy and can realize smooth insertion of optical fibers to the insertion holes to prevent the occurrence of latent damage.

### BRIEF DESCRIPTION OF THE DRAWINGS

FIG. 1 is a schematic diagram of a fiber array for optical communication which is an embodiment of the optical connector according to the present invention;

FIG. 2 is a schematic diagram of a ferrule for optical communication which is an embodiment of the optical connector according to the present invention;

FIG. 3 is an enlarged view of an insertion hole part in the optical connector of the present invention;

FIG. 4 is a diagram showing an example of a conventional fiber array for optical communication that is provided with V-shaped grooves; and

FIG. 5 is a schematic cross-sectional view of an optical connector in another embodiment of the present invention.

### BEST MODE FOR CARRYING OUT THE INVENTION

The optical connector of the present invention and a method for manufacturing the same will be described in detail with reference to the accompanying drawings.

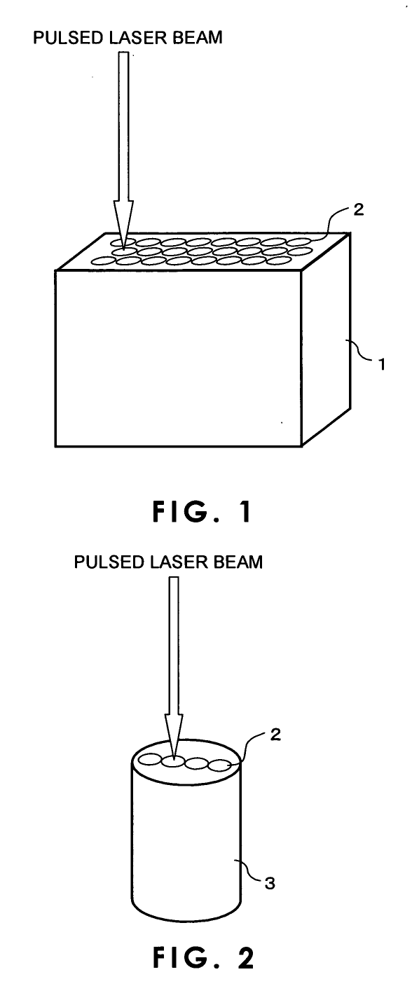

FIGS. 1 and 2 are a schematic diagram of a fiber array for optical communication in an embodiment of the present invention and a schematic diagram of a ferrule for optical communication in an embodiment of the present invention, respectively. A rectangular substrate 1 or a cylindrical substrate 2 is first provided as a substrate. The substrate is formed of a transparent material such as glass composed mainly of silicon oxide, a glass ceramic, quartz glass or light-transparent alumina, from the viewpoint of preventing heat damage to the substrate at the time of laser beam machining which will be described later. Therefore, the content of impurities such as Na₂O, K₂O, CaO, and BaO contained in the substrate is preferably not more than 50 ppm. When the impurity content exceeds 50 ppm, the transparency is lowered. Prior to boring, the end face of the substrate is subjected to optical polishing.

Boring is conducted by pulsed laser beam machining. The substrate is fixed with a holding jig, and the substrate is registered with a laser irradiation axis. The diameter of spots is regulated with an objective lens. The spot diameter is properly regulated depending upon the outer diameter of optical fibers used. In the present invention, the adoption of a method is particularly effective in which every time when an insertion hole is formed, the pulsed laser beam is condensed to a spot diameter of 10 to 130 μm.

In boring of the substrate, when glass or the like is used as the substrate, upon continuous application of a high-output laser beam, the substrate in its part exposed to the laser beam causes a rapid rise in temperature which in turn disadvantageously causes cracking of the substrate due to heat shock. For this reason, preferably, a pulsed laser beam is used for the laser beam machining. The pulsed laser beam for use in the boring, is not particularly limited, and conventional lasers such as YAG lasers and excimer lasers may be used. Among others, an argon ion-excited Ti-sapphire laser is preferred. “Femtosecond laser” which is suitably used in the present invention refers to one having a laser pulse width of not more than 1 ps.

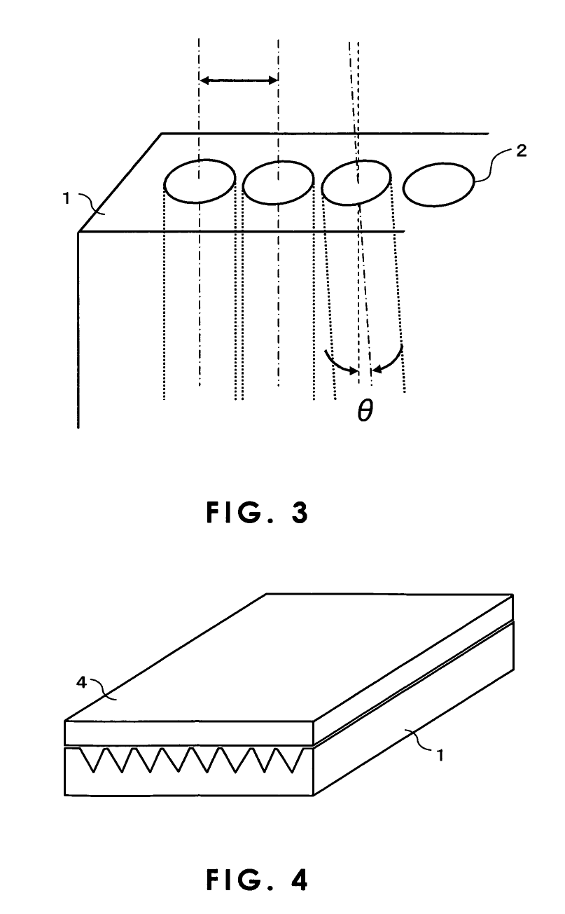

Insertion holes formed by pulsed laser beam machining are advantageous in that, by virtue of the nature of straight advance of the laser beam, even when a plurality of insertion holes are formed, the accuracy of the center-to-center dimension of adjacent insertion holes can be brought to ±0.5 μm or less. This can eliminate the need to conduct finish processing for accuracy improvement purposes after insertion hole formation. In addition to the improvement in the center-to-center dimension accuracy of the insertion holes, the axial parallel accuracy of a plurality of insertion holes can be brought to ±0.1 degree or less. Thus, very high-accuracy machining can be realized. As shown in FIG. 3, the center-to-center dimension accuracy of the insertion holes refers to a deviation from the average value of linear distances each defined by connecting the center of one insertion hole end to the center of the adjacent insertion hole. On the other hand, the axial parallel accuracy refers to the angle of the axis of each insertion hole to a reference axis (an axial direction perpendicular to the laser irradiation face of the substrate).

Further, as shown in FIG. 4, in a conventional array for optical communication of a type in which V-shaped grooves are formed in a substrate requires the use of a press plate, making it impossible to form a plurality of insertion holes at high density. On the other hand, as shown in FIG. 1 or 2, the use of a pulsed laser beam can realize the formation of insertion holes in a two-dimensional honeycomb form.

Further, it was unexpectedly found that a reduction in spacing between insertion holes for high-density arrangement of optical fibers can reduce coupling loss of the optical fibers. This is considered attributable to the fact that, in the formation of a plurality of insertion holes, the spacing between insertion holes located at both ends can be reduced by reducing the spacing between the holes, contributing to an improvement in dimensional accuracy of the insertion holes.

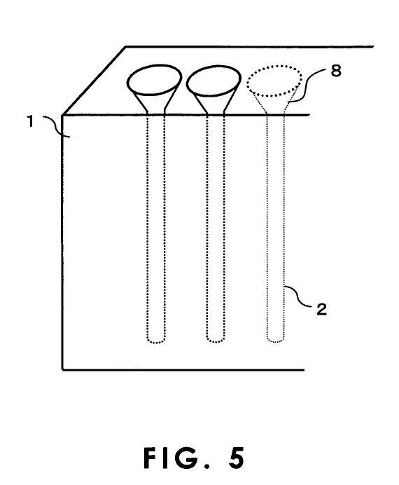

In the optical connector according to the present invention, as shown in FIG. 5, the end of the insertion hole 2 on the optical fiber insertion side is in a tapered form 5. The tapering of the hole end can reduce damage (latent damage) at the time of insertion of optical fibers and contact between the end and the side face of the optical fiber after insertion and fixation and can prevent damage to optical fibers. In the optical connector according to the manufacturing method according to the present invention, in forming insertion holes in the substrate, the tapering work can be continuously carried out. Unlike the prior art, in the optical connector according to the present invention, tapering after insertion hole formation is not required, and, thus, the number of working steps can be reduced. Further, when output and machining speed of the pulsed laser beam are regulated at the time of forming insertion holes, the formation of insertion holes and tapering of the end of holes can also be simultaneously carried out.

When the taper part is formed by cutting, an edge part formed on the inner wall of the taper part should be removed. Therefore, chamfering should be separately carried out for R-shape formation. When this chamfering for R-shape formation is unsatisfactory, optical fibers are broken during use of the optical connector. On the other hand, according to the manufacturing method of the present invention, since the taper part is formed by heat melting the substrate through pulsed laser beam machining, no edge occurs and, thus, chamfering for R-shape formation is unnecessary, contributing to simplification of the working process.

As described above, the insertion holes and taper part in the hole end formed by pulsed laser beam machining are characterized by a smooth inner wall surface. In some cases, however, crystal grains are formed in the inner wall of the insertion hole during laser beam machining. Therefore, preferably, after pulsed laser beam machining, the insertion holes and the taper part in the hole end are etched to remove the crystal grains. In this case, at least one inorganic acid selected from the group consisting of hydrofluoric acid, hydrochloric acid, nitric acid, and sulfuric acid can be used as an etching solution.

### EXAMPLES

### Example 1

An LD excited Ti sapphire pulsed laser beam with a pulse repetition frequency of 1 kHz and a center wavelength of 800 nm was condensed with an objective lens (magnification: 5 times) to regulate the spot diameter to 125 μm. The laser beam was applied to a quartz glass cylindrical substrate (bandgap of the material: 7.9 eV), with a diameter of 3 mm and a height of 20 mm, having a laser irradiation face which had been subjected to optical polishing. Regarding irradiation conditions and machining speed, the pulse width was not more than 130 femtoseconds, the output was 200 mW, and the scanning speed was 100 μm. Four insertion holes were formed at intervals of 250 μm in the cylindrical substrate. Next, the cylindrical substrate with insertion holes formed therein was immersed in a 4 wt % aqueous hydrofluoric acid solution for one hr for etching with an ultrasonic cleaner. Thus, a four-core ferrule for optical communication was prepared.

The insertion holes of the ferrule for optical communication were cylindrical and had an inner diameter of 125 μm. The distance between mutually adjacent insertion holes was 250 μm±0.4 μm, and the degree of parallelization in the Z axis direction (direction perpendicular to laser beam irradiation face) of the insertion holes was ±0.07 degree. Further, it was confirmed that an about 60-degree taper part was formed in the insertion hole end on the laser irradiation side.

### Example 2

An LD excited Ti sapphire pulsed laser beam with a pulse repetition frequency of 1 kHz and a center wavelength of 800 nm was condensed with an objective lens (magnification: 5 times) to regulate the spot diameter to 125 μm. The laser beam was applied to a 5 mm-thick rectangular quartz glass substrate (bandgap of the material: 7.9 eV) having a laser irradiation face which had been subjected to optical polishing. Regarding irradiation conditions and machining speed, the pulse width was not more than 130 femtoseconds, the output was 200 mW, and the scanning speed was 100 μm. Ten insertion holes were formed at intervals of 250 μm in the substrate. Next, the cylindrical substrate with insertion holes formed therein was immersed in a 4 wt % aqueous hydrofluoric acid solution for one hr for etching with an ultrasonic cleaner. Thus, a ten-core fiber array for optical communication was prepared.

The insertion holes of the array for optical communication were cylindrical and had an inner diameter of 125 μm. The distance between mutually adjacent insertion holes was 250 μm±0.4 μm, and the center-to-center dimension between both ends of the ten insertion holes was 2250 μm±0.4 μm. The degree of parallelization in the Z axis direction (direction perpendicular to laser beam irradiation face) of the insertion holes was ±0.07 degree. Further, it was confirmed that an about 60-degree taper part was formed in the insertion hole end on the laser irradiation side.

Optical fibers were inserted into and fixed through bonding to the fiber array for optical communication, and the coupling loss was measured with a collimator. As a result, for the array with a hole interval of 250 μm, the coupling loss was 0.26 dB.

### Example 3

A ferrule for optical communication was prepared under the same machining conditions as in Example 2, except that, in the formation of the ten insertion holes, the interval of the insertion holes was changed to 125 μm.

The insertion holes of the ferrule for optical communication were cylindrical and had an inner diameter of 125 μm. The distance between mutually adjacent insertion holes was 250 μm±0.4 μm, and the center-to-center dimension between both ends of the ten insertion holes was 1125 μm±0.4 μm. The degree of parallelization in the Z axis direction (direction perpendicular to laser beam irradiation face) of the insertion holes was ±0.07 degree. Further, it was confirmed that an about 60-degree taper part was formed in the insertion hole end on the laser irradiation side.

In the same manner as in Example 2, optical fibers were inserted and fixed through bonding to the fiber ferrule for optical communication, and the coupling loss was measured. As a result, for the ferrule with a hole interval of 125 μm, the coupling loss was 0.15 dB.

### Comparative Example 1

A YAG laser beam with a fundamental wave at 1064 nm (double wave 532 nm, triple wave 355 nm) was condensed with an objective lens (magnification: 5 times) to regulate the spot diameter to 125 μm. The laser beam was applied to a 5 mm-thick rectangular quartz glass substrate (bandgap of the material: 7.9 eV) having a laser irradiation face which had been subjected to optical polishing. Regarding irradiation conditions and machining speed, the pulse energy was 5 mJ, and the scanning speed was 100 μm.

As a result, the surface of the substrate was recessed only slightly, and no insertion hole was formed. Further, the occurrence of microcracks was observed in the substrate surface exposed to the laser beam and the backside of the substrate.

### Comparative Example 2

Boring was carried out in the same manner as in Comparative Example 1, except that the type of the laser used was changed to an ArF excimer laser (wavelength 193 nm).

As a result, the irradiation energy of the laser is not absorbed in the substrate, and no insertion hole was formed.

### Comparative Example 3

Boring was carried out in the same manner as in Comparative Example 1, except that the type of the laser used was changed to an F₂ laser (wavelength 157 nm).

As a result, insertion holes (depth 5 mm) could not be formed although holes with a depth up to about 100 μm could be formed.

1-10. (canceled)

11. An optical connector comprising a plurality of insertion holes for inserting optical fibers therein, said insertion holes being provided at predetermined intervals, the accuracy of the center-to-center dimension between said insertion holes adjacent to each other being within ±0.5 μm, the degree of parallelization in the hole axis direction between said insertion holes adjacent to each other being within ±0.1 degree, wherein
the optical connector comprises a substrate formed of a material selected from the group consisting of glass composed mainly of silicon oxide, glass ceramic, quartz glass, translucent alumina, and zirconium oxide.

12. The optical connector according to claim 11, wherein said insertion holes are arranged in a two-dimensional honeycomb form.

13. The optical connector according to claim 11, wherein, in said insertion holes, the insertion hole end on the optical fiber insertion side has been tapered.

14. The optical connector according to claim 11, wherein said optical connector is a ferrule for optical communication or a fiber array for optical communication.

15. A method for manufacturing the optical connector of claim 11, said method comprising the steps of:
fixing a substrate for said optical connector;
regulating the hole axis direction on an optical fiber insertion side in said fixed substrate; and
forming insertion holes in the substrate with regulated hole axis direction by pulsed laser beam machining.

16. The method according to claim 15, further comprising the step of, in forming the insertion holes by pulsed laser beam machining, shaping the end of said insertion holes into a taper of a predetermined angle.

17. The method according to claim 15, further comprising the step of etching the inner wall of said insertion holes and taper part formed by said laser beam machining.

18. The method according to claim 15, wherein said pulsed laser beam is a femtosecond laser beam.

19. The method according to claim 17, wherein said etching is carried out with at least one inorganic acid selected from the group consisting of hydrofluoric acid, hydrochloric acid, nitric acid, and sulfuric acid.
